(19) United States
(12) Patent Application Publication
(10) Pub. No.: US 2010/0074715 A1
(43) Pub. Date: Mar. 25, 2010

(54) Bookbinding device

(75) Inventors: Teruhito Oka, Arida-gun (JP); Hiroshi Miyawaki, Wakayama-shi (JP); Hiroo Michii, Kyoto-shi (JP)

Correspondence Address: JORDAN AND HAMBURG LLP, 122 EAST 42ND STREET, SUITE 4000, NEW YORK, NY, 10168, US

(73) Assignee: NORITSU KOKI CO., LTD., Wakayama-shi (JP)

(21) Appl. No.: 12/586,124

(22) Filed: Sep. 17, 2009

(30) Foreign Application Priority Data
Sep. 19, 2008 (JP) 2008-241482

(51) Int. Cl. B42B 9/00

(52) U.S. Cl. 412/28

(57) ABSTRACT

The bookbinding device of the present invention includes: a pair of holders capable of changing postures between a first posture of holding and restraining a lateral portion of a sheet bundle covered with a cover sheet, and a second posture of releasing the restraint; a tabular heating plate capable of generating heat for melting the hot-melt adhesive; a tabular cooling plate; a movable support plate which is arranged movably below the holders and supports the heating plate and the cooling plate; a first drive unit for changing the posture of the holders to the first posture or the second posture; a second drive unit for moving the movable support plate between a first position where the heating plate is positioned at a lower side of a holding space where the holders hold the sheet bundle, and a second position where the cooling plate is positioned at a lower side of the holding space; and a controller for controlling the operation of the first drive unit and the second drive unit.

### BACKGROUND OF THE INVENTION

1. Field of the Invention

The present invention relates to a bookbinding device for bonding, with a hot-melt adhesive, one side of a sheet bundle to be bound and a back cover face of a cover sheet for covering such sheet bundle.

2. Description of the Background Art

Generally speaking, in bundle-type bookbinding of covering the sheet bundle with a cover sheet, a method of disposing a hot-melt sheet as an adhesive on the reverse side of the back cover face of the cover sheet, and heating the back cover in a state of covering the sheet bundle with a cover sheet is being adopted. This kind of bundle-type bookbinding system is applied to photo albums and the like that are formed by covering a plurality of photo prints with a decorative cover sheet.

As a bookbinding device that performs bundle-type bookbinding, the bookbinding device disclosed in Japanese Patent Laid-Open Publication No. 2003-231375 is known. This bookbinding device includes a pressing plate that is able to freely exchange a heating plate and a cooling plate, and a clamp plate for holding one-book worth of sheet bundle. The back cover portion of the cover sheet is mounted on the pressing plate, and a cut piece of the hot-metal sheet is additionally mounted on the back cover. Then, the back cover portion is pressed with the heating plate, and heating is performed in a state where a hot-metal sheet is pressed against the one side of the sheet bundle held with the clamp plate. After the hot-metal sheet is melted with a predetermined time of pressing and heating, the pressure portion is switched to the cooling plate to cool the back cover portion, and the melted hot-melt sheet is thereby solidified. Consequently, the reverse side of the back cover face and the one side of the sheet bundle are bonded, and the bookbinding is thereby complete.

Nevertheless, the foregoing bookbinding device adopts a method of pressing the heating or cooling plate against the one side of the sheet bundle in a state where the sheet bundle is held, from start to finish, by the clamp plate. Consequently, there is a drawback in that the adhesiveness of the reverse side of the back cover face and the one side of the sheet bundle will deteriorate if the alignment status of the sheet bundle is inferior or the clamp status of the sheet bundle by the clamp plate is inferior.

### SUMMARY OF THE INVENTION

Thus, an object of the present invention is to provide a bookbinding device in bundle-type bookbinding capable of favorably bonding the back cover portion and the sheet bundle.

The bookbinding device according to one aspect of the present invention is a bookbinding device for bonding, with a hot-melt adhesive, one side of a sheet bundle to be bound and a back cover face of a cover sheet for covering the sheet bundle, including: a pair of holders capable of changing postures between a first posture of holding and restraining a lateral portion of the sheet bundle covered with the cover sheet, and a second posture of releasing the restraint; a tabular heating plate capable of generating heat for melting the hot-melt adhesive; a tabular cooling plate; a movable support plate which is arranged movably below the holders and supports the heating plate and the cooling plate; a first drive unit for changing the posture of the holders to the first posture or the second posture; a second drive unit for moving the movable support plate between a first position where the heating plate is positioned at a lower side of a holding space where the holders hold the sheet bundle, and a second position where the cooling plate is positioned at a lower side of the holding space; and a controller for controlling the operation of the first drive unit and the second drive unit; wherein the controller sequentially controls the first drive unit and the second drive unit as follows: in a preheating stage of preheating the heating plate, moving the movable support plate to the second position, and causing the holders to assume the first posture at least when the preheating is ended, in a heating stage of melting the hot-melt adhesive, moving the movable support plate to the first position, and thereafter causing the holders to assume the second posture, and in a cooling stage of solidifying the melted hot-melt adhesive, causing the holders to assume the first posture, and thereafter moving the movable support plate to the second position.

### BRIEF DESCRIPTION OF THE DRAWINGS

FIG. 1 is a perspective view showing the appearance of the bookbinding device according to an embodiment of the present invention;

FIG. 2A and FIG. 2B are diagrams showing the booklet to be bound with the bookbinding device, wherein FIG. 2A is an exploded view of the booklet and FIG. 2B is a diagram showing the status immediately before the booklet is bound with the bookbinding device;

FIG. 3 is a side view showing the internal structure of the bookbinding device;

FIG. 4 and FIG. 5 are diagrams explaining the drive operation of the holders based on the holder drive mechanism;

FIG. 6 is a top view of the movable support plate;

FIG. 7 to FIG. 10 are diagrams explaining the moving status of the heating plate and the cooling plate based on the moving mechanism;

FIG. 11 is a block diagram showing the control configuration of the bookbinding device; and

FIG. 12A to 12E are views showing a frame format explaining the control operation of the holder drive mechanism and the moving mechanism by the controller.

### DESCRIPTION OF THE PREFERRED EMBODIMENTS

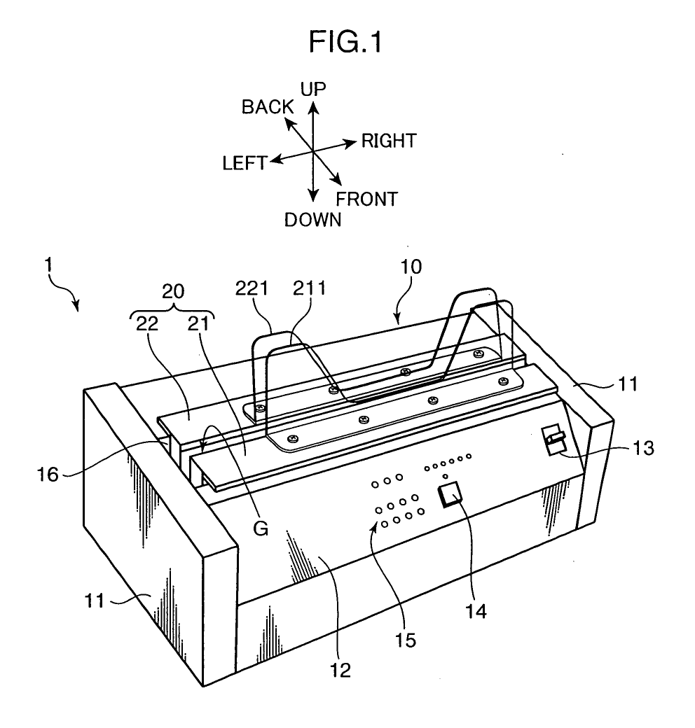

An embodiment of the present invention is now explained in detail with reference to the attached drawings. FIG. 1 is a perspective view showing the appearance of the bookbinding device 1 according to an embodiment of the present invention. The bookbinding device 1 is used for bonding, with a hot-melt adhesive, the one side of the sheet bundle to be bound and the back cover face of the cover sheet for covering such sheet bundle. The bookbinding device 1 has a case structure covered with a main body cover 10, and includes a holder 20 disposed at the opening of the main body cover 10.

Both lateral faces of the main body cover 10 are covered with a pair of lateral covers 11. The portion of the front face cover 12 of the main body cover 10 is provided with a power switch 13, a start switch 14 and an indicator 15. The start switch 14 is a switch for starting the sequence of sequentially executing the preheating stage, the heating stage and the cooling stage described later to the bookbinding device 1. The indicator 15 is a display unit for display which stage of the sequence is being executed, the heating status of the heating plate, or the remaining time of the sequence by illuminating an LED light or the like.

The holder 20 includes a front holder 21 and a rear holder 22 (pair of holders) that are movable in a direction of moving closer to or away from each other. An insertion space G is provided between the front holder 21 and the rear holder 22. The top surfaces of the front holder 21 and the rear holder 22 are respectively provided with a transparent front guide plate 211 and a rear guide plate 221.

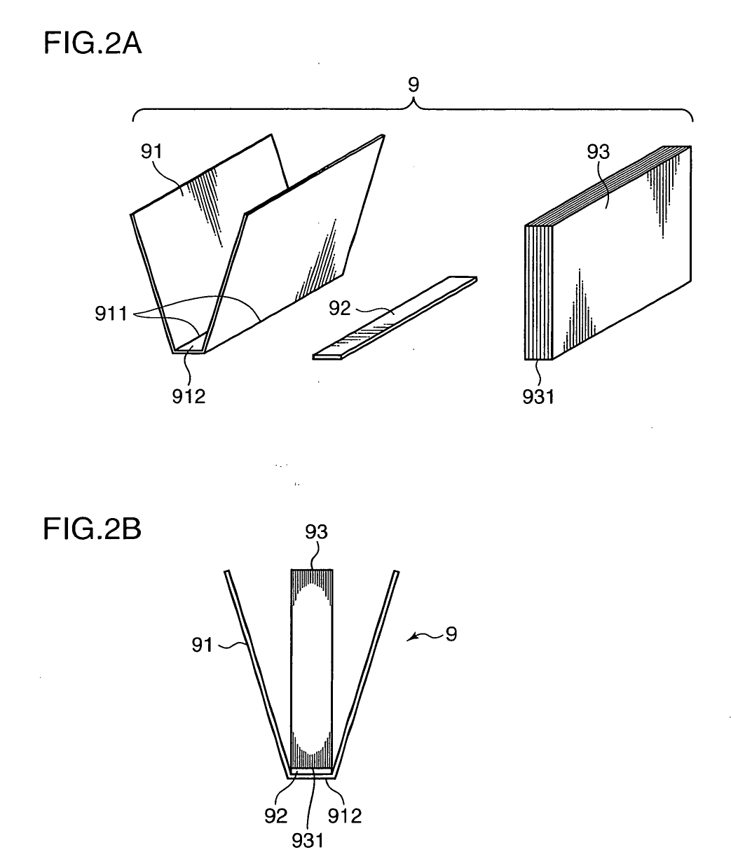

FIG. 2A and FIG. 2B are diagrams showing a booklet 9 to be bound with the bookbinding device 1, wherein FIG. 2A is an exploded perspective view of the booklet 9, and FIG. 2B is an end face view showing the status immediately before the booklet 9 is bound with the bookbinding device 1. The booklet is configured from a cover sheet 91, a hot-melt sheet 92 (hot-melt adhesive), and a sheet bundle 93. Two creases 911 are provided near the center of the cover sheet 91, and the section between the two creases 911 forms a back cover 912. The hot-melt sheet 92 is an adhesive sheet that is a solid at room temperature and which melts when heated, and is a strip-shaped sheet that is cut according to the width size of the back cover 912 from a mother sheet. The sheet bundle 93 is formed, for instance, by laminating a plurality of sheets of recording paper or photo prints.

When performing the bookbinding processing with the bookbinding device 1, the user assembles, as shown in FIG. 2B, the cover sheet 91, the hot-melt sheet 92 and the sheet bundle 93. Specifically, the hot-melt sheet 92 is mounted on the counter part of the cover sheet 91 folded at the two creases 911; that is, mounted on the reverse side of the back cover 912. Moreover, the sheet bundle 93 is housed within the cover sheet 91 so that one side 931 of the sheet bundle 93 is placed on the hot-melt sheet 92 so as to complete the booklet 9. The user manually holds the booklet 9, and inserts it into the insertion space G of the bookbinding device 1 from the back cover face 912 side. The user subsequently presses the start switch 14 to cause the bookbinding device 1 to execute the heating processing. The hot-melt sheet 92 is thereby heated and melted, and the cover sheet 91 and the sheet bundle 93 are bonded at the reverse side of the back cover 912, and the bookbinding processing of the booklet 9 is thereby complete.

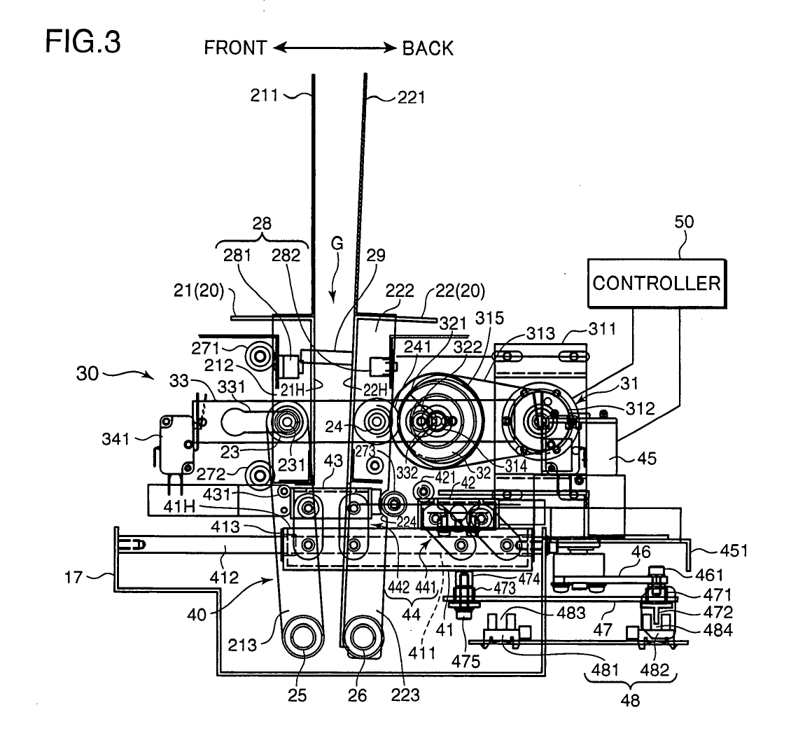

The internal structure of the bookbinding device 1 is now explained. FIG. 3 is a side view showing a state where the lateral cover 11 on the right side of FIG. 1 has been removed. Incidentally, in FIG. 3, the respective members are drawn with a solid line regardless of their anteroposterior relationship for the sake of convenience of explanation, and the illustration of certain members has been omitted. The main body cover 10 of the bookbinding device 1 internally includes attached components for changing the posture of the holder 20, a holder drive mechanism 30 for driving the holder 20, a moving mechanism 40 for driving the heating plate 42 and the cooling plate 43 described later, and a controller 50 for controlling the operation of the holder drive mechanism 30 and the moving mechanism 40.

The front holder 21 and the rear holder 22 are members formed by bending a metallic flat plate into a reverse L-shape, and have holding surfaces 21H, 22H for holding the booklet 9. The holding surfaces 21H, 22H are flat surfaces that extend in the horizontal direction of the bookbinding device 1, and they face each other with the insertion space G therebetween. The front holder 21 is fixed to and supported by a first retention frame 212 that is disposed on the reverse side of the holding surface 21H. Similarly, the rear holder 22 is fixed to and supported by a second retention frame 222 that is disposed on the reverse side of the holding surface 22H. As described in detail later, the front holder 21 and the rear holder 22 are movable in the anteroposterior direction (refer to FIG. 1) of the bookbinding device 1.

A cylindrical first pin 23 is provided protrusively to the lateral side of the first retention frame 212 and a cylindrical second pin 24 is provided to the lateral side of the second retention frame 222, respectively. A first shaft 25 and a second shaft 26 to become the fulcrum for oscillating the front holder 21 and the rear holder 22 are provided at a lower side position of the first pin 23 and the second pin 24 in the vicinity of the bottom cover 17. The first pin 23 and the first shaft 25, and the second pin 24 and the second shaft 26 are respectively linked with a first oscillating bar 213 and a second oscillating bar 223 that are disposed on the lateral side of the first retention frame 212 and the second retention frame 222.

An engagement hole is provided in the vicinity at the upper end and lower end of the first oscillating bar 213, and the first pin 23 is rotatably fitted into the engagement hole of the upper end side and the first shaft 25 is rotatably fitted into the engagement hole of the lower end side, respectively. Accordingly, when the front holder 21 moves in the anteroposterior direction, the first oscillating bar 213 rotates about the axis of the first shaft 25, also rotates about the axis of the first pin 23, and the angle in relation to the first retention frame 212 will change. Moreover, an engagement hole is provided in the vicinity at the lower end of the second oscillating bar 223, and the second shaft 26 is rotatably fitted into the engagement hole. Incidentally, the upper part of the second oscillating bar 223 is formed integrally with the lateral side of the second retention frame 222, and, when the rear holder 22 moves in the anteroposterior direction, the second oscillating bar 223 rotates only about the axis of the second shaft 26.

Three holder stoppers 271, 272, 273 are arranged around the front holder 21 and the rear holder 22. These stoppers are formed from columnar rubber members, fixedly mounted on a main body frame (not shown), restrict the movement of the front holder 21 and the rear holder 22, and alleviate the impact associated with the movement. Two stoppers 271, 272 are disposed on the side of the front holder 21 so as to come in contact with and stop the back face side of the first retention frame 212. Moreover, one stopper 273 is disposed on the side of the rear holder 22 so as to come in contact with and stop the back face side of the second oscillating bar 223. In correspondence with the positions where the stopper 273 is disposed, a semicircular concave portion 224 is provided to the second oscillating bar 223.

A work detection sensor 28 is provided to the upper side position of the front holder 21 and the rear holder 22. The work detection sensor 28 is a sensor for optically detecting whether work such as the booklet 9 has been inserted into the insertion space G. The work detection sensor 28 includes a sensor unit 281 and a reflective part 282 placed opposite each other so as to sandwich the insertion space G. The sensor unit 281 includes a light emitting element and a light receiving element, and the light emitting element emits light to the reflective part 282 through a through-hole drilled in the front holder 21 and the rear holder 22, and the light receiving element receives the reflected light. The work detection sensor 28 detects the existence of the work based on the emitted/received light being shielded when the work is inserted into the insertion space G.

A width restricting member 29 is provided so as to bridge the insertion space G in the anteroposterior direction. The width restricting member 29 is provided as a pair of left and right members in the vicinity at the end portion of the insertion space G in the horizontal direction, and functions to restrict the end position of the work in the horizontal direction.

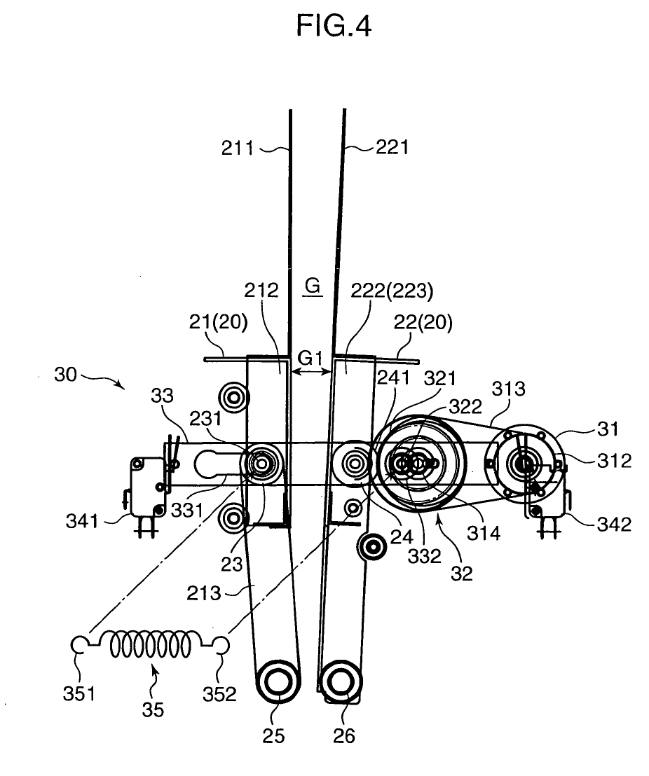

The holder drive mechanism 30 (first drive unit) is now explained. The holder drive mechanism 30 performs the drive of changing postures between a first posture of holding and restraining the front holder 21 and the rear holder 22 at the lateral side of the booklet 9 (work), and a second posture of releasing the restraint. The holder drive mechanism 30 includes a first motor 31, a cam member 32, a tension plate 33, a pair of limit switches 341, 342, and a coil spring 35 (refer to FIG. 4).

The first motor 31 is, for example, a stepping motor, and generates the driving force for driving the front holder 21 and the rear holder 22. The first motor 31 is fixed to a mounting plate 311 that is arranged in an erect manner on the main body frame. A drive pulley 312 is fixed to the output axis of the first motor 31.

The cam member 32 is a plate cam that is mounted rotatably and integrally on and with the axis member 314, and includes a cam face 321 and a traction pin 322. A driven pulley 315 is also mounted rotatably and integrally on and with the axis member 314, and a timing belt 313 is placed across the driven pulley 315 and the drive pulley 312. When the drive pulley 312 rotates based on the drive of the first motor 31, the rotational driving force is transmitted to the cam member 32 via the timing belt 313, the driven pulley 315 and the axis member 314, and the cam member 32 rotates about the axis of the axis member 314.

The cam face 321 includes a short diameter part in which the distance from the shaft center is relatively short, and a long diameter part in which the distance from the shaft center is relatively long, is constantly in contact with the cam stay 241 provided to the second pin 24, and presses the second retention frame 222 via the second pin 24. The traction pin 322 is a columnar protrusion that is provided protrusively from the lateral face of the cam member 32 in the horizontal direction, and is provided protrusively on the side of the short diameter part of the cam face 321 which is at a position that is decentered from the center (mounting position of the axis member 314) of the cam member 32.

The tension plate 33 is a rectangular plate member that is long in the anteroposterior direction, and has a long hole 331 and a circular hole 332. The long hole 331 is a hole that is long in the anteroposterior direction, and a protruding cylindrical portion 231 provided at the tip side of the first pin 23 is fitted therein. Meanwhile, the traction pin 322 of the cam member 32 is fitted into the circular hole 332. Accordingly, when the cam member 32 rotates, the tension plate oscillates in the anteroposterior direction, and the protruding cylindrical portion 231 moves relatively in the long hole 331 according to the foregoing oscillation.

The limit switches 341, 342 are arranged at either end of the tension plate 33 in the anteroposterior direction, and include a contact part that is pressed at the end portion of the tension plate 33. With one limit switch 341, the contact point is turned ON when the tension plate 33 moves to the limit position in the forward direction. With the other limit switch 342, the contact point is turned ON when the tension plate 33 moves to the limit position in the rear direction.

Although FIG. 4 shows a state where it is removed, one end side 351 of the coil spring 35 is mounted on the protruding cylindrical portion 231, and the other end side 352 is mounted on the traction pin 322. The coil spring 35 is a tension coil spring, and the biasing force that is applied between the protruding cylindrical portion 231 and the traction pin 322 will change depending on the rotational phase of the cam member 32; that is, the position of the traction pin 322.

The drive operation of the front holder 21 and the rear holder 22 by the holder drive mechanism 30 is now explained with reference to FIG. 4 and FIG. 5. FIG. 4 shows a state where the space between the front holder 21 and the rear holder 22 is open (second posture), and FIG. 5 shows a state where such space is closed (first posture), respectively. In the second posture illustrated in FIG. 4, the short diameter port of the cam face 321 provided to the cam member 32 and the cam stay 241 of the second pin 24 come in contact. Moreover, the traction pin 322 of the cam member 32 is positioned toward the rear holder 22.

In the foregoing status, the protruding cylindrical portion 231 is pressed at the rear peripheral edge of the long hole 331 of the tension plate 33, and the front holder 21 retained by the first retention frame 212 will be in a state of being relatively distant in the forward direction from the center of the insertion space G. Here, the first oscillating bar 213 will rotate about the axis of the first shaft 25 and become inclined, and also rotate about the axis of the first pin 23 and become bent in relation to the first retention frame 212. Moreover, as a result of the cam stay 241 coming in contact with the short diameter part of the cam face 321, the second retention frame 222 (second oscillating bar 223) will tilt about the axis of the second shaft 26. Accordingly, the rear holder 22 will be in a state of being relatively distant in the rear direction from the center of the insertion space G.

Consequently, the gap of the insertion space G between the front holder 21 and the rear holder 22 will become a relative expanded distance G1. This distance G1 is sufficiently longer than the thickness of the booklet 9 to be bound. Accordingly, even if the booklet 9 is inserted into the insertion space G in the foregoing state, the booklet 9 will not be restrained by the holder 20. Incidentally, in the second posture, the distance between the traction pin 322 and the protruding cylindrical portion 231 is relatively short, and the coil spring 35 is not generating tensile biasing force.

When the phase of the cam member 32 is changed 180 degrees from the second posture illustrated in FIG. 4, it becomes the first posture shown in FIG. 5. In the first posture of FIG. 5, the long diameter part 323 of the cam face 321 and the cam stay 241 come in contact, and the traction pin 322 will be in a state of being separated from the rear holder 22.

In this state, the protruding cylindrical portion 231 will be pulled by the coil spring 35, and the front holder 21 that is retained by the first retention frame 212 will be towed in the direction heading toward the center of the insertion space G. Here, the first oscillating bar 213 rotates about the axis of the first shaft 25 and becomes approximately erect, and also rotates about the axis of the first pin 23 and becomes approximately straight in relation to the first retention frame 212. Moreover, as a result of the cam stay 241 coming in contact with the long diameter part 323 of the cam face 321, the second retention frame 222 (second oscillating bar 223) is pressed, and will rotate in a direction that is erect about the axis of the second shaft 26. Accordingly, the rear holder 22 will be in a state of being close to the center of the insertion space G.

Consequently, the gap of the insertion space G between the front holder 21 and the rear holder 22 will be a relatively short distance G2. This distance G2 is shorter than the thickness of the booklet 9 to be bound. When the booklet 9 is inserted into the insertion space G in the foregoing state, the lateral side of the booklet 9 will be held and restrained by the holder 20. In the first posture, the distance between the traction pin 322 and the protruding cylindrical portion 231 is relatively long, and the coil spring 35 will generate tensile biasing force in a state of holding the booklet 9. The booklet 9 is restrained based on this tensile biasing force.

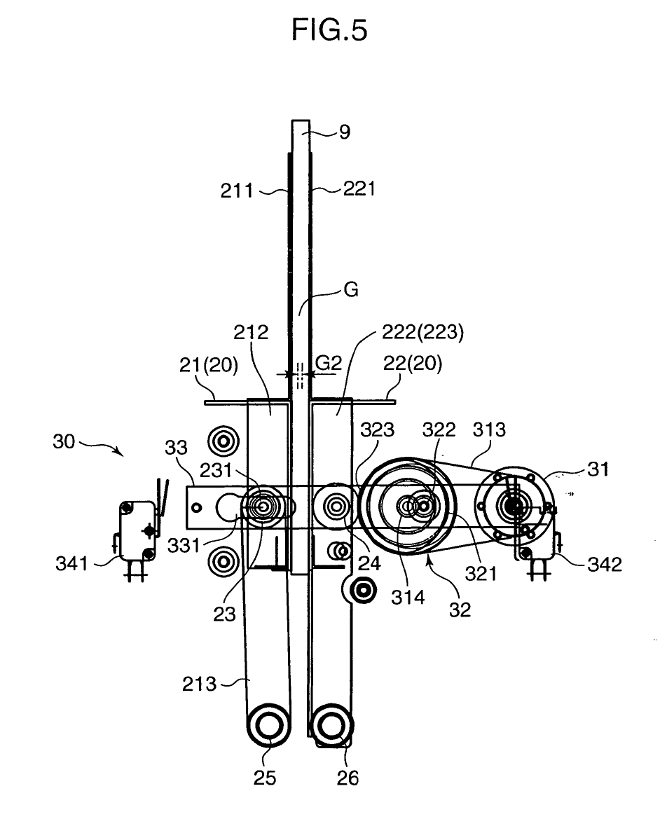

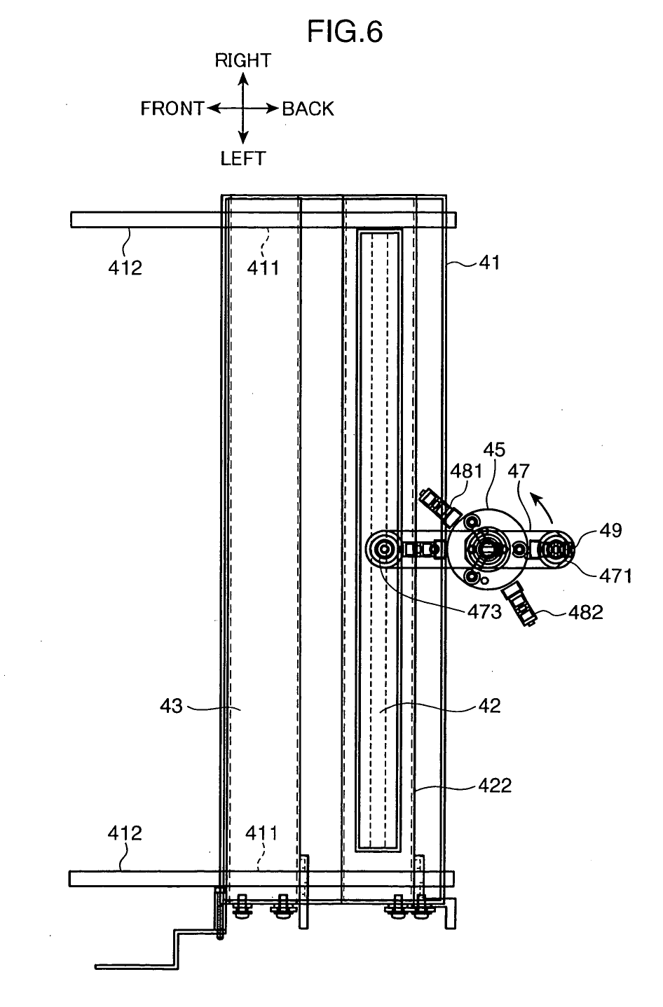

The moving mechanism 40 (second drive unit) is now explained by returning to FIG. 3. The bookbinding device 1 includes a tabular heating plate 42 for generating heat to melt the hot-melt sheet 92 of the booklet 9, and a tabular cooling plate 43. The moving mechanism 40 is used for alternatively moving the heating plate 42 or the cooling plate 43 to the lower side of the holding space (insertion space G) for the holder 20 to hold the booklet 9, and includes a movable support plate 41, a link mechanism 44, a second motor 45, a rotating arm 46, a linking arm 47, a position sensor 48 and a home sensor 49 (FIG. 6). FIG. 6 is a top view of the movable support plate 41.

The movable support plate 41 is arranged movably in the anteroposterior direction (horizontal direction) below the holder 20, and supports the heating plate 42 and the cooling plate 43 in a parallel state. The movable support plate 41 is a rectangular flat plate member, and a through-hole 411 extending in the anteroposterior direction is provide to either end of the long side thereof. A moving axis 412 extending in the anteroposterior direction and supported horizontally by the bottom cover 17 is inserted through the through-hole 411, and the movable support plate 41 moves horizontally in the anteroposterior direction along the moving axis 412. Incidentally, a slide bushing 413 is mounted at the anteroposterior of the through-hole 411.

The heating plate 42 is a member for heating the back cover face 912 of the booklet 9 in a state of being inserted into the insertion space G, and melting the hot-melt sheet 92 extending toward the reverse side of the back cover face 912. The heating plate 42 is, as shown in FIG. 6, an elongated electrical heater, and has a width that is slighter shorter than the width of the movable support plate 41 in the longitudinal direction (horizontal direction). The heating plate 42 is retained at the top surface of the heater support 422. The heater support 422 is a rectangular member that has the same longitudinal direction width as the movable support plate 41, and a width that is wider than the anteroposterior direction width of the heating plate 42. The portion including the heater support 422 is sometimes simply referred to as the heating plate 42.

The cooling plate 43 cools and thereby promotes the solidification of the hot-melt sheet 92 that was heated and melted with the heating plate 42, and bonds the one side 931 of the sheet bundle 93 to the reverse side of the back cover face 912. The cooling plate 43 is formed from a metal plate having the same size as the heater support 422 from a planar view. As the cooling plate 43, preferably metal with superior radiation performance is used and, for instance, an aluminum plate may be used.

The heating plate 42 and the cooling plate 43 are disposed on the top surface 41H of the movable support plate 41, and are linked to the lateral side of the movable support plate 41 in the horizontal direction with the link mechanism 44. The link mechanism 44 is a mechanism for changing the states of the heating plate 42 and the cooling plate 43 respectively between a lifted state of being lifted upward from the top surface 41H of the movable support plate 41, and a lowered state of in proximity to the top surface 41H.

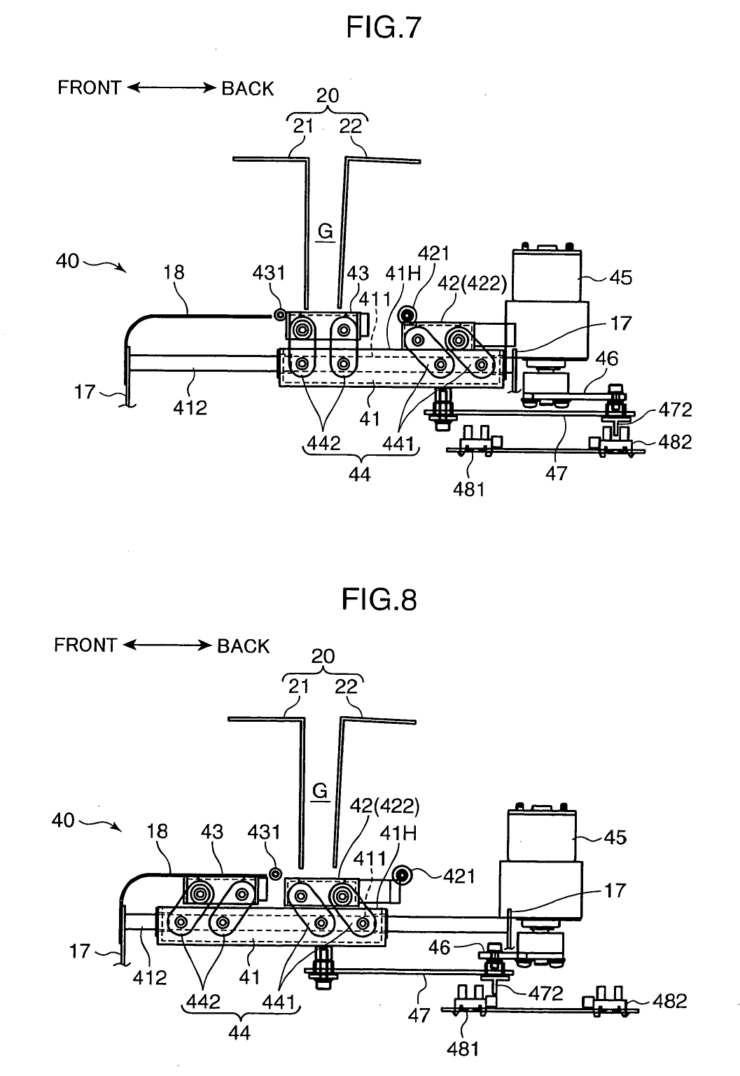

The link mechanism 44 includes a heating plate link 441 and a cooling plate link 442, and FIG. 3 shows a case where the heating plate link 441 is tilted and the heating plate 42 is in a lowered state, and the cooling plate link 442 is erected and the cooling plate 43 is in a lifted state. The movement of the heating plate 42 in the anteroposterior direction is restricted with the heating plate restricting part 421. Moreover, the movement of the cooling plate 43 in the anteroposterior direction is restricted with the cooling plate restricting part 431. Based on the movement restrictions by the heating plate restricting part 421 and the cooling plate restricting part 431, a difference arises between the displacement of the heating plate 42 and the cooling plate 43, and the displacement of the movable support plate 41. Consequently, the heating plate 42 and the cooling plate 43 will change between a lifted state and a lowered state via the link mechanism 44. This point is now explained in further detail with reference to FIG. 7 to FIG. 10.

The second motor 45 is, for example, a stepping motor, and generates the driving force for moving the movable support plate 41. The second motor 45 is fixed to a mounting plate 451 that is provided to the main body frame. The base end side of a rotating arm 46 is mounted fixedly to the output axis of the second motor 45, and rotates based on the rotational drive of the second motor 45.

The linking arm 47 is a member for mechanically linking the rotating arm 46 and the movable support plate 41. One end of side the linking arm 47 is rotatably linked to a tip side of the rotating arm 46 via a first bearing 471 and a screw 461. Moreover, the other side of the linking arm 47 is rotatably linked to a boss part 474 provided protrusively at the lower face of the movable support plate 41 via a second bearing 473 and a screw 475. Based on the crank movement of the rotating arm 46 and the linking arm 47 associated with the rotational drive of the second motor 45, the movable support plate 41 reciprocates in the anteroposterior direction along the moving axis 412.

The position sensor 48 is a sensor for detecting the position of the heating plate 42 and the cooling plate 43 in correspondence with the position of the tip side of the rotating arm 46. The position sensor 48 is configured from a first position sensor 481 and a second position sensor 482 disposed respectively on the orbital trajectory of the tip of the rotating arm 46. The respective sensors 481, 482 includes a light emitting element and a light receiving element placed opposite each other and including light shielding gaps 483, 484. When the rotating arm 46 is rotated, the light shielding piece 472 that is provided protrusively to the lower part of the first bearing 471 passes through the light shielding gaps 483, 484 of the respective sensors 481, 482. When the light shielding piece 472 is in a position of shielding the light emitted from the first position sensor 481, the heating plate 42 is positioned at the lower side of the insertion space G (first position). Meanwhile, when the light shielding piece 472 is positioned to shield the light emitted from the second position sensor 482, the cooling plate 43 is positioned at the lower side of the insertion space G (second position).

The home sensor 49 is a sensor for detecting the home position of the movable support plate 41 in correspondence with the position of the tip side of the rotating arm 46. In this embodiment, the home position is a position where the movable support plate 41 is drawn to the rearmost side.

The moving, lifting and lowering operation of the heating plate 42 and the cooling plate 43 by the moving mechanism 40 is now explained with reference to FIG. 7 to FIG. 10. Incidentally, in FIG. 7 to FIG. 10, illustrations for explaining the operation for changing the posture of the front holder 21 and the rear holder 22 are omitted.

FIG. 7 shows a state where the movable support plate 41 is moved to the rear side so as to position the cooling plate at the lower side of the insertion space G (second position), and a state where the cooling plate 43 is in a lifted state based on the cooling plate link 442, and the heating plate 42 is in a lowered state based on the heating plate link 441. If the booklet 9 is inserted into the insertion space G in the foregoing state, the back cover face 912 will be cooled with the cooling plate 43.

In the state illustrated in FIG. 7, the tip of the rotating arm 46 is positioned at the rear side of the bookbinding device 1 in relation to the output axis of the second motor 45, and the movable support plate 41 is pulled toward the rear side via the linking arm 47. As a result of the movement of the cooling plate 43 toward the rear side being restricted with the cooling plate restricting part 431, the cooling plate 43 is unable to follow the posterior movement of the movable support plate 41. Consequently, the cooling plate link 442 is erected, the cooling plate 43 is separated from the top surface 41H of the movable support plate 41 and lifted upward, and thereby approaches the lower end of the holder 20. Meanwhile, the heating plate link 441 is tilted toward the anterior side, and thereby approaches the top surface 41H of the heating plate 42. The heating plate 42 is not restricted by the heating plate restricting part 421 in the foregoing state, and follows the posterior movement of the movable support plate 41. In the foregoing state, the light shielding piece 472 is shielding the light from reaching the second position sensor 482, and the controller 50 recognizes this state by receiving a detection signal from the second position sensor 482.

FIG. 8 shows a state where the movable support plate 41 is moved toward the anterior side so as to position the heating plate 42 at the lower side of the insertion space G (first position), but both the heating plate 42 and the cooling plate 43 are of a lowered state. The booklet 9 that is inserted into the insertion space G in the foregoing state will be restrained by the holder 20, and will not drop.

In the state illustrated in FIG. 8, the tip of the rotating arm 46 is positioned at the anterior side in relation to the output axis of the second motor 45, and the movable support plate 41 fed to the anterior side via the linking arm 47. During the initial stage of the anterior movement of the movable support plate 41 from the state illustrated in FIG. 7, the movement of the cooling plate 43 is restricted by the cooling plate restricting part 431. Consequently, the cooling plate link 442 is gradually tilted toward the rear side, and the cooling plate 43 will approach the top surface 41H of the movable support plate 41. Incidentally, the top surface of the cooling plate 43 is guided with the guide plate 18 mounted on the bottom cover 17. The heating plate 42 moves by following the anterior movement of the movable support plate 41 without change from the state of FIG. 7. However, the heating plate 42 will thereafter be subject to the restriction of the heating plate restricting part 421, and will no longer follow the anterior movement of the movable support plate 41.

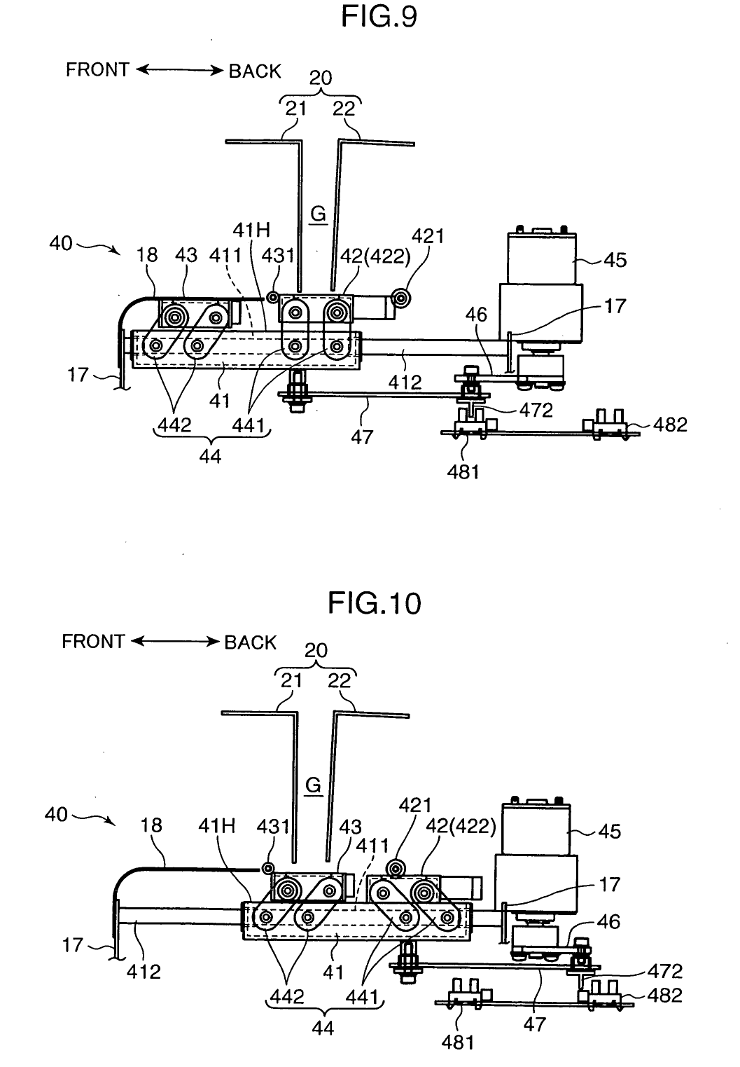

FIG. 9 shows a state where the heating plate 42 is positioned at the lower side of the insertion space G (second position), and the heating plate 42 is in a lifted state based on the heating plate link 441 and the cooling plate 43 is in a lowered state based on the cooling plate link 442. When the booklet 9 is inserted into the insertion space G in the foregoing state, the back cover face 912 can be heated with the heating plate 42.

In the state illustrated in FIG. 9, the movable support plate 41 moves further to the anterior side from the state of FIG. 8, but the movement of the heating plate 42 to the anterior side is restricted by the heating plate restricting part 421. Accordingly, the heating plate link 441 is operated, and the heating plate 42 will be separated from the top surface 41H of the movable support plate 41 and be lifted upward. Meanwhile, the cooling plate 43 will move by following the anterior movement of the movable support plate 41 without change from the state of FIG. 8. In the foregoing state, the light shielding piece 472 is shielding the light from reaching the first position sensor 481, and the controller 50 will recognize this state by receiving a detection signal from the first position sensor 481.

FIG. 10 shows a state where the movable support plate 41 is moved to the rear side so as to position the cooling plate at the lower side of the insertion space G (second position), but the heating plate 42 and the cooling plate 43 are both in a lowered state. The booklet 9 that is inserted into the insertion space G in the foregoing state will be restrained by the holder 20, and will not drop.

In the state illustrated in FIG. 10, the tip of the rotating arm 46 has returned to the rear side in relation to the output axis of the second motor 45, and the movable support plate 41 is pulled toward the rear side via the linking arm 47. During the initial stage of the posterior movement of the movable support plate 41 from the state illustrated in FIG. 9, the movement of the heating plate 42 is restricted by the heating plate restricting part 421. Consequently, the heating plate link 441 is gradually tilted toward the anterior side, and the heating plate 42 will approach the top surface 41H of the movable support plate 41. The cooling plate 43 moves by following the anterior movement of the movable support plate 41 without change from the state of FIG. 9. During the foregoing movement, the operation of the cooling plate link 442 is restricted by the guide plate 18. However, the cooling plate 43 will thereafter be subject to the restriction of the cooling plate restricting part 431, and will no longer follow the posterior movement of the movable support plate 41. When the rotational phase of the rotating arm 46 advances further, it arrives at the state illustrated in FIG. 7.

According to this kind of moving mechanism 40, the heating plate 42 and the cooling plate 43 can be alternately positioned at the lower side of the insertion space G based on the crank movement of the rotating arm 46 and the linking arm 47, and the position control of the heating plate 42 and the cooling plate 43 can be performed merely by controlling the rotation of the second motor 45. Moreover, when the heating plate 42 or the cooling plate 43 is positioned at the lower side of the insertion space G based on the link mechanism 44, these plates 42, 43 will respectively become a lifted state, and will otherwise be in a lowered state under other conditions. Accordingly, when the heating plate 42 and the cooling plate 43 are moved by the movable support plate 41, the back cover face 912 of the booklet 9 in a state of being restrained by the holder 20 will not interfere with the heating plate 42 or the cooling plate 43. Thus, the back cover face 912 will not be damaged by frictional sliding or the movement of the heating plate 42 and the cooling plate 43 will not be impaired.

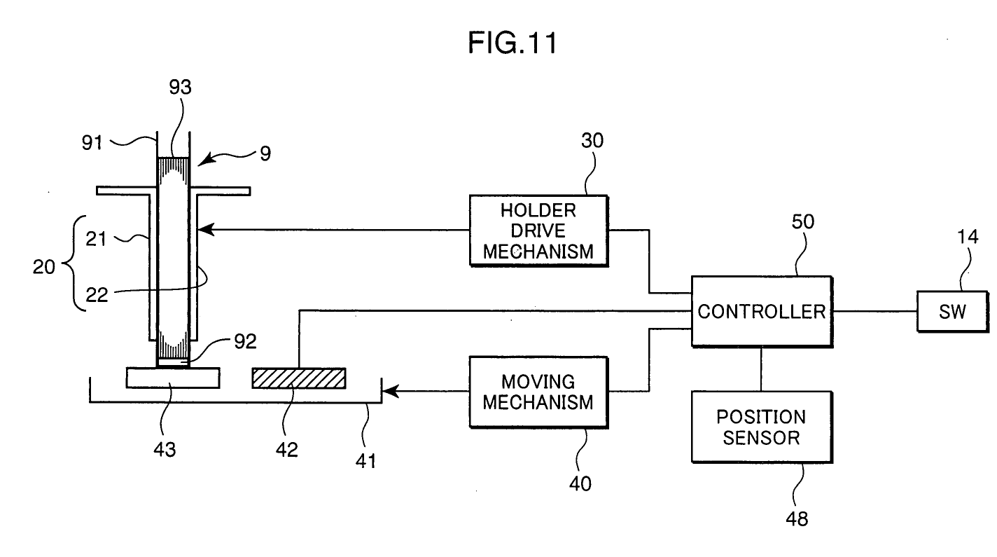

The controller 50 is now explained. FIG. 11 is a block diagram showing the control configuration of the bookbinding device 1. The controller 50 controls the operation of the holder drive mechanism 30 (first motor 31) and the moving mechanism 40 (second motor 45), as well as performs the energization control to the heating plate 42. The detection signal of the position sensor 48 is referred to in performing the foregoing control.

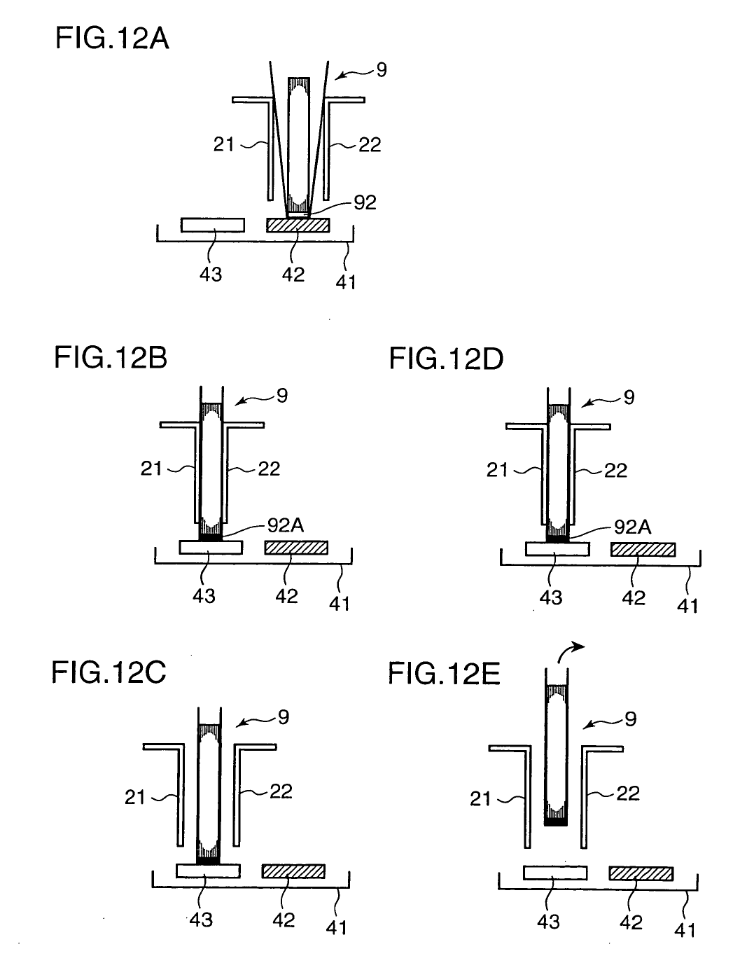

The bookbinding process of the booklet 9 by the bookbinding device 1 can be broadly classified into a preheating stage of starting the energization to the heating plate 42 and preheating the heating plate 42 until it stably generates heat of a prescribed temperature, a heating stage of heating and melting the hot-melt sheet 92, which is enclosed by the booklet 9, with the heating plate 42, and a cooling stage of solidifying the hot-melt sheet 92 that was melted at the heating stage and bonding the cover sheet 91 and the sheet bundle 93 at the reverse side of the back cover face 912. The controller 50 sequentially controls the operation of the holder drive mechanism 30, the moving mechanism 40 and the heating plate 42 as shown in FIG. 12A to FIG. 12E with the state illustrated in FIG. 11 as the starting point upon sequentially executing the foregoing stages.

FIG. 11 shows a state where the preheating stage is being executed. The user inserts the pre-bound booklet 9 that is assembled as shown in FIG. 2B into the insertion space G of the holder 20, and then presses the start switch 14. In response, the controller 50 drives the first motor 31 of the holder drive mechanism 30, and causes the front holder 21 and the rear holder 22 to assume the first posture of holding and restraining the lateral side of the booklet 9. Moreover, the controller 50 drives the second motor 45 of the moving mechanism 40 to position the cooling plate 43 at the lower side of the insertion space G (second position), and move the movable support plate 41 so that the cooling plate 43 becomes a lifted state based on the cooling plate link 442 (state of FIG. 7). Moreover, the controller 50 starts energizing the heating plate 42 and preheats the heating plate 42.

Incidentally, the restraint of the booklet 9 by the holder 20 may also be performed immediately before moving to the heating stage (i.e., immediately after the preheating stage is complete). Moreover, the movable support plate 41 can also be moved from the home position of FIG. 6 to the state of FIG. 7 with the input of the power switch 13 as the trigger.

FIG. 12A shows the state where the heating stage is being executed. When the preheating stage is complete, the controller 50 drives the second motor 45 to position the heating plate 42 at the lower side of the insertion space G (first position), and move the movable support plate 41 to become a lifted state based on the heating plate link 441 (state of FIG. 9). The movement of the movable support plate is stopped based on the detection signal of the first position sensor 481.

Subsequently, the controller 50 drives the first motor to cause the front holder 21 and the rear holder 22 to assume the second posture, and release the restraint of the booklet 9. In this state, the back cover face 912 of the booklet 9 is heated with the heating plate 42, and the hot-melt sheet 92 is thereby melted. Here, since the booklet 9 is not restrained by the front holder 21 and the rear holder 22, the one side 931 of the sheet bundle 93 will sink into the hot-melt sheet 92 that is gradually melting based on the sheet bundle 93′s own weight. Accordingly, the hot-melt adhesive can easily enter between the sheets on the one side 931, and the reliable adhesiveness of the one side 931 of the sheet bundle 93 and the reverse side of the back cover face 912 can thereby be ensured.

FIG. 12B shows a state of starting the cooling stage. When the heating stage is ended after heating is performed for a predetermined amount of time, the controller 50 drives the first motor 31 and causes the front holder 21 and the rear holder 22 to assume the first posture and restrain the booklet 9. The controller 50 thereafter drives the second motor 45 and positions the cooling plate 43 at the lower side of the insertion space G (second position), and move the movable support plate 41 to become a lifted state based on the cooling plate link 442. The movement of the movable support plate 41 is stopped based on the detection signal of the second position sensor 482, and the energization to the heating plate is also stopped based on this detection signal. Subsequently, the cooling plate 43 cools the back cover face 912 and solidifies the melted hot-melt sheet 92A.

In this cooling stage, as shown in FIG. 12C, the controller 50 drives the first motor 31 to temporarily release (approximately 0.5 seconds) the restraint of the booklet 9 by the front holder 21 and the rear holder 22, and thereafter restrains the booklet 9 with the front holder 21 and the rear holder 22 once again as shown in FIG. 12D.

As described above, by instantaneously releasing the restraint of the booklet 9, the back cover face 912 can be reliably landed on the cooling plate 43. Specifically, when restraining the booklet 9 with the front holder 21 and the rear holder 22, there are cases where the booklet 9 is lifted higher than the prescribed position or tilted due to one reason or another. Thus, as a result of instantaneously releasing the restraint of the booklet 9, and the flaw in the posture of the booklet 9 can be resolved, and the back cover face 912 can thereby be reliably attached to the cooling plate 43. Consequently, the melted hot-melt sheet 92A can be reliably cooled and solidified. Incidentally, since the release of the restraint of the booklet 9 is instantaneous, there will be no substantial influence in the formation of the bookbinding in the cooling stage.

Subsequently, when a predetermined time for solidifying the hot-melt sheet 92A lapses after the start of the cooling stage, the controller 50 controls the first motor 31 so as to cause the front holder 21 and the rear holder 22 to assume the second posture, and release the restraint of the booklet 9. FIG. 12E shows the state where such restraint is released. With the release of the restraint of the booklet 9 as the trigger; that is, as a result of knowing that the front holder 21 and the rear holder 22 have opened, the user will be able to recognize that the cooling stage has ended; that is, the bookbinding is complete. Conversely, since the booklet 9 is restrained in a state where the cooling is not complete, it is possible to prevent the booklet 9 from being removed in a state where the cooling is not complete.

According to the bookbinding device 1 of the present embodiment explained above, the back cover portion and the sheet bundle can be bonded reliably without having to release the restraint of the booklet 9 as a result of moving the heating plate 42 and the cooling plate 43, and not executing the heating stage and the cooling stage, and appropriately performing the restraint and release of the booklet 9 by the holder 20.

Although the bookbinding device 1 according to an embodiment of the present invention was described above, the present invention is not limited and, for instance, may also adopt the following embodiments.

(1) In the foregoing embodiment, an example was shown where the cooling plate 43 is configured from a metallic flat plate. The cooling plate 43 may also be configured by attaching a cooling element such as a peltiert element or internally forming a refrigerant path for performing active cooling. Moreover, the cooling plate 43 may also be held by a cooling plate support formed from another member.
(2) In the foregoing embodiment, an example was shown where the heating plate 42 and the cooling plate 43 are caused to be in a lifted state and a lowered state with the link mechanism 44. In substitute for this link mechanism 44, an eccentric cam or a hydraulic mechanism, or an actuator or the like may be used to achieve the foregoing lifted state and the lowered state. Otherwise, the link mechanism 44 may be omitted, and in substitute a lifting and lowering mechanism may be attached to the holder 20 for performing the lifting and lowering.
(3) After the cooling stage is ended, some kind of operation for notifying the user of the completion of the bookbinding may be performed. As the notification operation, for example, methods such as causing the indicator 15 to flash or generating a beeping sound may be used. Otherwise, a mechanism for causing the booklet 9 to jump toward the upper side of the insertion space G simultaneously with the completion of the cooling stage can be provided, and the configuration may be such that the jumping of the booklet 9 is used to notify the completion of the bookbinding to the user.
(4) In the foregoing embodiment, an example was shown where the movable support plate 41 is movable in the horizontal direction and supports the heating plate 42 and the cooling plate 43 in a parallel state. In substitute, the heating plate and the cooling plate 43 may be mounted on a rotating support plate.

Incidentally, the specific embodiments described above mainly include the invention having the following configurations.

The bookbinding device according to one aspect of the present invention is a bookbinding device for bonding, with a hot-melt adhesive, one side of a sheet bundle to be bound and a back cover face of a cover sheet for covering the sheet bundle, including: a pair of holders capable of changing postures between a first posture of holding and restraining a lateral portion of the sheet bundle covered with the cover sheet, and a second posture of releasing the restraint; a tabular heating plate capable of generating heat for melting the hot-melt adhesive; a tabular cooling plate; a movable support plate which is arranged movably below the holders and supports the heating plate and the cooling plate; a first drive unit for changing the posture of the holders to the first posture or the second posture; a second drive unit for moving the movable support plate between a first position where the heating plate is positioned at a lower side of a holding space where the holders hold the sheet bundle, and a second position where the cooling plate is positioned at a lower side of the holding space; and a controller for controlling the operation of the first drive unit and the second drive unit; wherein the controller sequentially controls the first drive unit and the second drive unit as follows: in a preheating stage of preheating the heating plate, moving the movable support plate to the second position, and causing the holders to assume the first posture at least when the preheating is ended, in a heating stage of melting the hot-melt adhesive, moving the movable support plate to the first position, and thereafter causing the holders to assume the second posture, and in a cooling stage of solidifying the melted hot-melt adhesive, causing the holders to assume the first posture, and thereafter moving the movable support plate to the second position.

According to the foregoing configuration, after moving the movable support plate to the first position in the heating stage, the controller causes the holders to assume the second posture of restraining the sheet bundle, and the releases the restraint of the sheet bundle. Consequently, it is possible to cause the one side of the sheet bundle to sink into the hot-melt adhesive that is gradually melting based on the sheet bundle's own weight. Accordingly, the reliable adhesiveness of the one side of the sheet bundle can thereby be ensured.

In the foregoing configuration, preferably, after the movement of the movable support plate to the second position is complete in the cooling stage, the controller controls the first drive unit so as to temporarily cause the holders to assume the second posture, and thereafter return the holders to the first posture.

According to the foregoing configuration, since the holders are caused to temporarily assume the second posture and the restraint of the sheet bundle is released, the back cover portion of the cover sheet covering the sheet bundle can be reliably attached to the cooling plate. Consequently, it is possible to reliably cool and solidify the melted hot-melt adhesive. Incidentally, since the release of the restraint of the sheet bundle is temporary, there will be no substantial influence in the formation of the bookbinding in the cooling stage.

In the foregoing configuration, preferably, when a predetermined time for solidifying the hot-melt adhesive lapses after the start of the cooling stage, the controller controls the first drive unit so as to cause the holders to assume the second posture.

According to the foregoing configuration, the completion of the cooling stage; that is, the completion of the bookbinding can be notified to the user with the release of the sheet bundle by the holder as the trigger. Conversely, it is possible to prevent the sheet bundle from being removed in a state where the cooling is not complete. Moreover, when the user is to remove the sheet bundle, since the restraint of the sheet bundle has already been released, the sheet bundle can be easily removed.

In the foregoing configuration, preferably, the movable support plate is arranged movably in the horizontal direction, and supports the heating plate and the cooling plate in a parallel state. According to the foregoing configuration, the position can be easily changed between the first position and the second position simply by moving the movable support plate horizontally.

In the foregoing case, preferably, the bookbinding device further comprises a link mechanism for respectively linking the heating plate and the cooling plate with the movable support plate, wherein the link mechanism causes the heating plate to be in a lifted state of being lifted upward from the movable support plate and causes the cooling plate to be in a lowered state in proximity to the movable support plate when the movable support plate is in the first position, causes the cooling plate to be in the lifted state and causes the heating plate to be in the lowered state when the movable support plate is in the second position, and causes both the heating plate and the cooling plate to be in the lowered state when the movable support plate changes its position between the first position and the second position.

According to the foregoing configuration, the link mechanism can be used to cause the heating plate and the cooling plate to be in a lifted state and a lowered state, respectively. In particular, when the heating plate or the cooling plate is positioned at the lower side of the holding space of the sheet bundle, these plates respectively become a lifted state, and become a lowered state in other conditions. Accordingly, when the heating plate and the cooling plate are moved with the movable support plate, the back cover portion of the cover sheet in a state of being restrained by the holder will not frictionally slide due to the foregoing plates, and it is thereby possible to prevent the back cover from being damaged.

As described above, according to the present invention, it is possible to provide a bookbinding device in bundle-type bookbinding where the back cover portion and the sheet bundle can be reliably bonded by moving the heating plate and the cooling plate, and appropriately restraining and releasing the sheet bundle by the holder.

This application is based on Japanese patent application serial no. 2008-241482, filed in Japan Patent Office on Sep. 19, 2008, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A bookbinding device for bonding, with a hot-melt adhesive, one side of a sheet bundle to be bound and a back cover face of a cover sheet for covering the sheet bundle, comprising:
a pair of holders capable of changing postures between a first posture of holding and restraining a lateral portion of the sheet bundle covered with the cover sheet, and a second posture of releasing the restraint;
a tabular heating plate capable of generating heat for melting the hot-melt adhesive;
a tabular cooling plate;
a movable support plate which is arranged movably below the holders and supports the heating plate and the cooling plate;
a first drive unit for changing the posture of the holders to the first posture or the second posture;
a second drive unit for moving the movable support plate between a first position where the heating plate is positioned at a lower side of a holding space where the holders hold the sheet bundle, and a second position where the cooling plate is positioned at a lower side of the holding space; and
a controller for controlling the operation of the first drive unit and the second drive unit; wherein
the controller sequentially controls the first drive unit and the second drive unit as follows:
in a preheating stage of preheating the heating plate, moving the movable support plate to the second position, and causing the holders to assume the first posture at least when the preheating is ended,
in a heating stage of melting the hot-melt adhesive, moving the movable support plate to the first position, and thereafter causing the holders to assume the second posture, and
in a cooling stage of solidifying the melted hot-melt adhesive, causing the holders to assume the first posture, and thereafter moving the movable support plate to the second position.

2. The bookbinding device according to claim 1, wherein
after the movement of the movable support plate to the second position is complete in the cooling stage, the controller controls the first drive unit so as to temporarily cause the holders to assume the second posture, and thereafter return the holders to the first posture.

3. The bookbinding device according to claim 1, wherein
when a predetermined time for solidifying the hot-melt adhesive lapses after the start of the cooling stage, the controller controls the first drive unit so as to cause the holders to assume the second posture.

4. The bookbinding device according to claim 1, wherein
the movable support plate is arranged movably in the horizontal direction, and supports the heating plate and the cooling plate in a parallel state.

5. The bookbinding device according to claim 4, further comprising:
a link mechanism for respectively linking the heating plate and the cooling plate with the movable support plate; wherein
the link mechanism causes the heating plate to be in a lifted state of being lifted upward from the movable support plate and causes the cooling plate to be in a lowered state in proximity to the movable support plate when the movable support plate is in the first position, causes the cooling plate to be in the lifted state and causes the heating plate to be in the lowered state when the movable support plate is in the second position, and causes both the heating plate and the cooling plate to be in the lowered state when the movable support plate changes its position between the first position and the second position.
